(19) United States
(12) Patent Application Publication
(10) Pub. No.: US 2025/0353037 A1
(43) Pub. Date: Nov. 20, 2025

(54) LAMINATED CARD COMPRISING A THERMOCHROMIC PATTERN AND METHOD FOR MANUFACTURING SUCH A CARD

(71) Applicant: IDEMIA FRANCE, Courbevoie (FR)

(72) Inventors: Justine DEBRIFFE, Courbevoie (FR); Inès DAUDE, Courbevoie (FR); Caroline WEISSKOPP, Courbevoie (FR)

(73) Assignee: IDEMIA FRANCE, Courbevoie (FR)

(21) Appl. No.: 18/873,133

(22) PCT Filed: Sep. 2, 2022
(86) PCT No.: PCT/FR2022/051660

§ 371 Date: Dec. 9, 2024

(51) Int. Cl. B05D 7/00; B05D 3/02; B05D 5/06; C09K 9/00

(52) U.S. Cl. CPC B05D 7/572; B05D 3/0254; B05D 5/061; C09K 9/00; B05D 2201/02; B05D 2501/00; B05D 2502/00

(57) ABSTRACT

A laminated card and a method for manufacturing such a card. The card includes a thermoplastics backing layer, an adhesive layer, a primer layer, a thermochromic pattern which is printed using a thermochromic ink, and a plastics protective layer. The primer layer is suitable for the thermochromic ink, enabling good adhesion of the thermochromic pattern to the lower layers such as to the backing layer via the adhesive layer. The adhesive layer and the primer layer are both water-based or both polymerised under UV radiation. The thermochromic ink includes a liquid crystal compound.

### TECHNICAL FIELD OF THE INVENTION

The present invention relates to a laminated card and to a process for the manufacture of such a card.

The invention is targeted in particular at a card suitable for containing information. Such a card can be an identification means, for example an identity card, or a payment means, such as a payment card.

### STATE OF THE ART

A common problem concerning cards of this type intended to contain information, and in particular personal information, is ensuring a high level of security.

In this context, the document EP 3045321 discloses a card and the process for the manufacture thereof. The card comprises a plurality of laminated layers. At least one thermochromic pattern is printed on one of the layers, said thermochromic pattern having a thermochromic ink composition comprising the leuco dye.

Such a thermochromic ink exhibits a first color when its temperature is within a given range of temperatures, and becomes transparent when its temperature is outside said given range of temperatures.

It is thus possible to print, with the thermochromic ink, a pattern which it is desired to render visible or invisible as a function of the temperature, and in particular to render visible when the card has a temperature in the given range of temperatures. This pattern can, for example, be a security code, such as a cryptogram or CVV (card validation code) code of a payment card. The pattern becomes visible by changing color as soon as its temperature is outside the range of temperatures. For this purpose, the pattern is, for example, heated.

Thermochromic inks comprising leuco dye exhibit the disadvantage of having an activation time, that is to say the time necessary to change from their single color to transparency, which is slow. Moreover, thermochromic inks of this type only make a change in opacity of just one color possible.

### SUMMARY OF THE INVENTION

The present invention is targeted at providing a laminated card and a process for the manufacture of said card comprising at least one thermochromic pattern having a fast activation time.

To this end, it provides, according to a first aspect, a laminated card comprising, in order:
a thermoplastic support layer;
an adhesive layer;
a tie layer;
a thermochromic pattern printed by means of a thermochromic ink; and
a protective plastic layer,
   the adhesive layer and the tie layer both being water-based or being polymerizable under ultraviolet radiation, said thermochromic ink comprising a liquid crystal compound.

Preferably, the thermochromic ink does not comprise leuco dye.

The tie layer is suitable for the thermochromic ink. It is thus configured to make good adhesion of the thermochromic pattern (ink) to the lower layers, and thus to the support layer via the adhesive layer, possible.

By virtue of its particular structure, the card obtained exhibits very good mechanical properties while incorporating a thermochromic pattern having a fast activation time (of the order of one or two seconds).

In addition, a multiple change in color as a function of the temperature is obtained by virtue of the liquid crystal technology, unlike in particular a card comprising a thermochromic pattern with leuco dye which makes the change of only a single color to transparency possible.

The thermochromic pattern can be used to mask information, for example security data on a payment card. This information becomes visible only if the thermochromic pattern is heated to a certain temperature, called the activation temperature.

The thermochromic pattern can completely cover the surface of the card. Alternatively, the thermochromic pattern can cover a part, continuous or noncontinuous, of the surface of the card. The thermochromic pattern can be a design, one or more characters, a colored area, and the like. The surface of the card corresponds to the surface of the support layer.

The stacking and the choice of the various layers makes good adhesion between the layers possible, in particular an improved mechanical strength of the thermochromic pattern on the thermoplastic support layer, in particular a resistance to tearing or degradation of the protective layer. This is because several adhesion interfaces are formed for this. A first adhesion interface is formed by the adhesive layer and the support layer.

Conventional adhesives (water-based or UV-based) offering effective attaching can be used. A second adhesion interface is formed between the adhesive layer and the thermochromic pattern, by virtue of the tie layer. The tie layer is suitable for the thermochromic ink in order to make good adhesion of the thermochromic pattern possible.

The invention provides for the use of an adhesive layer and a tie layer of the same type (of the same base) in order to guarantee compatibility between the layers as well as a high adhesion between the two layers, and consequently between the thermochromic pattern and the support layer.

The peel strength between the various layers of the card is preferably at least 3.5 N. This peel strength can be measured by tests et seq. of the known standards, in particular the standards ISO 10373-1, ISO24-78962 or ISO 3225-19.

Finally, the various layers and in particular the adhesive layer and the tie layer are chosen so as not to damage the liquid crystals and to thus preserve the thermochromic pattern.

According to one characteristic, the liquid crystals are chiral nematic liquid crystals.

According to one characteristic, the liquid crystals are contained in microcapsules, said microcapsules having a diameter of less than 50 microns, preferably between 5 and 15 microns.

The thermochromic pattern can thus dry quickly.

The liquid crystal microcapsules consist, for approximately 80%, of an oleic liquid crystal mixture inside the microcapsules and, for approximately 20%, of dry microcapsule wall material.

According to one characteristic, the tie layer and the thermochromic ink comprise an identical compound. This presence of a common compound ensures that the tie layer is suitable for the thermochromic ink. The compound is in particular other than the water, the acrylic resin and the liquid crystal microcapsules which conventionally form the thermochromic ink.

Preferably, each of the tie layer and of the thermochromic ink comprises at least 10% of said identical compound.

According to one characteristic, the liquid crystal compound constitutes between 10% and 30% by weight of the thermochromic ink (used to form the thermochromic pattern), preferably 20% by weight of the thermochromic ink.

According to one characteristic, the thermochromic ink and the tie layer have an acrylic matrix.

The choice of an identical matrix, in particular the acrylic matrix, respectively for the thermochromic ink and the tie layer, makes it possible to have good compatibility and good adhesion between the layers.

According to one characteristic, the card additionally comprises a nonthermochromic pattern printed by means of a water-based ink or an ink polymerizable under ultraviolet radiation, the nonthermochromic pattern being printed on the support layer before the adhesive layer.

Printing the nonthermochromic pattern on the support layer before the printing of the adhesive layer prevents the migration of the ink from the nonthermochromic pattern toward the liquid crystals and thus the degradation of the latter. This is because the adhesive layer and the tie layer form an effective double barrier between the thermochromic pattern carrying the liquid crystals and the nonthermochromic pattern.

In addition, the liquid crystals are transparent when their temperature is not in a predefined temperature range and in particular when it is less than or greater than the activation temperature. The liquid crystals can thus advantageously be printed on a light-colored nonthermochromic pattern without needing to delimit the nonthermochromic pattern by a resist or knockout.

The laminated card can be a smart card. It is preferably in accordance with the ID-1 format, with or without a chip.

According to a second aspect, the invention provides a process for the manufacture of a laminated card comprising the following stages:
providing a thermoplastic support layer;
depositing an adhesive layer on the support layer;
depositing a tie layer on the dried adhesive layer, the adhesive layer and the tie layer preferentially both being water-based or both being polymerizable under ultraviolet radiation;
printing a thermochromic pattern on the dried tie layer by means of a thermochromic ink, said thermochromic ink comprising a liquid crystal compound;
depositing a protective plastic layer on the dried thermochromic pattern; and
laminating the assembly.

According to one characteristic, the process comprises, after the stage consisting in providing the support layer and before the stage consisting in depositing the adhesive layer, a stage consisting in printing a nonthermochromic pattern on the support layer by means of a water-based ink or of an ink polymerizable under ultraviolet radiation.

According to one characteristic, the stage consisting in laminating comprises the substages of:
hot laminating at a temperature between 120° C. and 160° C., preferably at 125° C., and a pressure between 30 N/cm² and 200 N/cm², preferably of 120 N/cm²; then
cold laminating at a temperature between 10° C. and 20° C., preferably at 15° C., and a pressure between 50 N/cm² and 300 N/cm², preferably of 100 N/cm².

According to one characteristic, in order to manufacture a laminated card, a thermochromic pattern of which exhibits an activation temperature T1, said thermochromic printing ink, before hot lamination, exhibits an activation temperature T0=T1+δ, where δ is of between 2° C. and 5° C. (for example, 3° C. or 4° C.).

It is thus possible to choose and adapt the thermochromic ink before lamination according to the activation temperature T1 desired after lamination. This is because the inventors have observed that the difference δ between the activation temperature T0 before lamination and the temperature T1 after lamination is due to the high pressure and high temperature to which the thermochromic pattern is subjected during the lamination stage.

### BRIEF DESCRIPTION OF THE FIGURES

Other distinguishing features and advantages of the invention will become more apparent in the description below with reference to the appended drawings, which are given by way of nonlimiting example:

FIG. 1 is a diagrammatic representation of the front of a laminated card;

FIG. 2 is a diagrammatic representation of the back of the laminated card of FIG. 1;

FIG. 3 is a diagrammatic view, in cross section, of a laminated card according to one embodiment of the invention; and

FIG. 4 is a diagrammatic view, in cross section, of a laminated card according to another embodiment of the invention.

### DETAILED DESCRIPTION

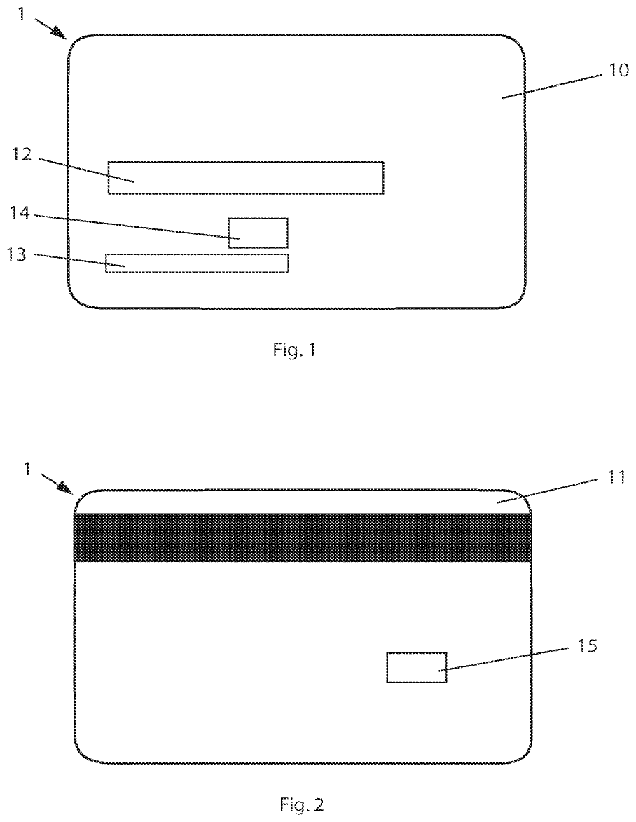

FIGS. 1 and 2 diagrammatically represent a card, in particular a payment card 1.

The card 1 exhibits in this instance a typical ID-1 format, corresponding to the format of payment cards.

The payment card 1 comprises a front face 10, represented in FIG. 1, and a back face 11, represented in FIG. 2.

The payment card 1 conventionally comprises several printed items of information. The front face 10 of the payment card comprises, for example, the number of the card, referenced 12, the name of the cardholder, referenced 13, and the expiry date of the card, referenced 14. The back face 11 of the payment card comprises other types of information, for example a cryptogram or security code making it possible to identify the holder.

The card 1 can comprise a chip in the form of a flush contact chip module (not illustrated).

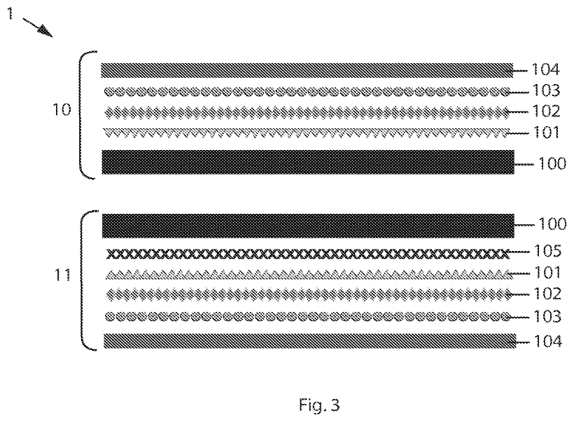

FIG. 3 represents a diagrammatic cross section of the payment card 1 according to one embodiment of the invention.

The payment card 1 comprises several stacked layers. The payment card 1 is laminated. In other words, the layers of the payment card 1 undergo a lamination, that is to say a heat treatment under pressure of the various layers in order to assemble them permanently so as to form an object (in this instance, the payment card).

The payment card 1 comprises a support. The support comprises at least one layer, called the support layer 100. The support comprises, in this instance, two layers of PVC support 100 added, by adhesive bonding, to a layer of inlay or substrate. A first support layer 100 acts as a base for the front 10 of the payment card 1. A second support layer 100 acts as a base for the back 11 of the payment card 1.

The support is made of thermoplastic or, in other words, the support layers 100 are made of thermoplastic.

The thermoplastic is preferably polyvinyl chloride (PVC). The support is, for example, made of polyvinyl chloride (PVC). The thermoplastic can alternatively be chosen from the group of the following materials: acrylonitrile-butadiene-styrene (ABS), polyvinyl chloride (PVC), polycarbonate (PC), polyethylene terephthalate (PET), polyetheretherketone (PEEK), polyethylene naphthalate (PEN), PLA (polylactic acid), PBS (polybutylene succinate) and PA (polyamide). Other examples are possible.

The support is preferably dark in color, for example black.

The front 10 and the back 11 of the payment card 1 exhibit, in this instance, substantially the same structure. The description of the layers constituting the front 10 of the payment card 1 thus also applies to the back 11 of the payment card 1.

The front of the payment card 1 comprises an adhesive layer 101 and a tie layer or primer layer 102.

The adhesive layer 101 extends over the support layer 100.

The adhesive layer 101 can cover all or part of a face of the support layer 100.

The tie layer 102 extends over the adhesive layer 101. The tie layer 102 can cover all or part of a face of the first adhesive layer 101.

The adhesive layer 101 and the tie layer 102 are different.

The adhesive layer 101 and the tie layer 102 are both preferentially water-based or polymerizable under ultraviolet radiation.

The adhesive layer 101 and the tie layer 102 thus have an identical base, which makes it possible to ensure good compatibility and good adhesion between these layers.

The water-based adhesive for the adhesive layer 101 exhibits the advantage of slightly liquefying when it is laminated, thus making good adhesion between the layers possible, between which layers the adhesive is applied.

The adhesive layer 101 and the tie layer 102 have, for example, an acrylic matrix.

The front 10 of the payment card also comprises a thermochromic pattern 103. The term “thermochromic pattern” is understood to mean a pattern, the color of which changes as a function of its temperature.

The thermochromic pattern 103 extends, in this instance, over the entire surface of the card. In an alternative form of this flat surface, the thermochromic pattern 103 can be partial. The thermochromic pattern 103 can thus constitute a local pattern, such as an inscription and/or a form. In such an embodiment, the adhesive layer 101 and the tie layer 102 are preferentially local, extending so as to cover at least the same area as the thermochromic pattern 103.

The thermochromic pattern 103 is printed on the tie layer 102. The thermochromic pattern 103 is printed by means of a thermochromic ink. The tie layer 102 is suitable for the thermochromic ink used, in order to ensure good adhesion of this ink (and thus of the thermochromic pattern 103 formed) to the lower layer 101.

The thermochromic ink is preferably an acrylic ink.

The thermochromic ink is thus compatible with the adhesive layer 101 and the tie layer 102.

The thermochromic ink used is preferentially water-based, solvent-based inks being liable to damage the microcapsules.

The thermochromic ink uses an active principle of liquid crystal type. In other words, the thermochromic ink comprises liquid crystal compounds, in particular in the form of liquid crystal microcapsules.

The thermochromic ink is typically an aqueous solution which comprises, in addition to the water, liquid crystals, the acrylic resin and optional pigments. The tie layer 102 is suitable for the thermochromic ink in that they comprise an identical compound distinct from those above, in a proportion of at least 10% by weight, preferably between 10% and 30% by weight, typically 20%.

The liquid crystal phases constitute an intermediate state existing between the crystalline solid and the completely disorderly liquid phase.

The liquid crystals are, in this instance, chiral nematic liquid crystals or cholesteric liquid crystals.

The liquid crystals are microencapsulated in the ink. More precisely, a mixture containing liquid crystals is microencapsulated in the ink. Liquid crystal typical mixtures contain several chemical substances and are optically active oily mixtures. During the microencapsulation process, droplets of oily liquid crystal mixtures are surrounded by a polymer coating to give microcapsules having diameters of between 5 and 15 microns. The process subsequently comprises a stage of combining the microcapsules with polymers or resins and water to produce the ink.

The thermochromic ink thus contains microcapsules enclosing the liquid crystals in an acrylic matrix, namely a water base incorporating an acrylic resin and optional pigments. The liquid crystal microcapsules consist, for approximately 80%, of an oleic liquid crystal mixture inside the microcapsules and, for approximately 20%, of dry microcapsule wall material.

Documents FR2322914, FR2361456, U.S. Pat. No. 4,149,413 and FR2386594 describe examples of liquid crystal typical mixtures which can be used. Document U.S. Pat. No. 3,697,297 describes an example of microencapsulated liquid crystals which can be used.

The liquid crystal ink selectively reflects the incident light. The liquid crystals change color when a certain temperature, referred to as activation temperature, is reached and continue to change with the increase in the temperature. The liquid crystals are transparent when their temperature is outside a predefined range of temperatures having, for the lower limit, the activation temperature and, for the upper limit, a temperature referred to as deactivation temperature. The liquid crystals are thus transparent when their temperature is less than the activation temperature or greater than the deactivation temperature. The liquid crystals assume different colors of the visible spectrum when their temperature is within the predefined range of temperatures. In the predefined range of temperatures, the liquid crystals change in particular from red toward blue as the temperature increases.

By virtue of the liquid crystals of the thermochromic ink, the thermochromic pattern 103 changes color according to its temperature.

The change in color of the thermochromic ink is reversible. In other words, the change in color is observed in the reverse direction when the temperature decreases.

The change in color of the thermochromic ink is perfectly repeatable. Another heating beyond the activation temperature will again make the color of the thermochromic pattern 103 change.

The dark, preferably black, layer of the support layers 100 provides good visibility of the colors reflected by the liquid crystal ink.

The tie layer 102 ensures good adhesion of the thermochromic pattern 103 to the support layer 100.

The tie layer 102 extending between the adhesive layer 101 and the thermochromic pattern 103 additionally makes it possible to create a protective barrier for the thermochromic pattern 103. In other words, the tie layer 102 makes it possible to protect the thermochromic pattern 103 from the compounds of the adhesive layer 101.

In another exemplary embodiment, a second tie layer 102 might also be deposited between the thermochromic pattern 103 and the protective layer 104.

The front 10 of the payment card 1 also comprises a protective layer 104, also referred to as “overlay”.

The protective layer 104 covers the thermochromic pattern 103. The protective layer 104 exhibits the same dimensions and shape as the support.

The protective layer 104 is, for example, a film.

The protective layer 104 is made of thermoplastic.

The protective layer 104 is preferably a plastic film. The protective layer 104 can, for example, be made of polyvinyl chloride (PVC), polycarbonate (PC) or polyethylene terephthalate glycol (PETG).

The protective layer 104 is coated in order to make its adhesion to the remainder of the payment card possible. The protective layer 104 is in particular coated with a water-based adhesive.

The protective layer 104 is configured to protect the payment card from wear. The protective layer 104 also makes it possible to protect the thermochromic pattern.

The protective layer 104 can be treated against UV radiation or comprise UV absorbers in order to protect the liquid crystals of the thermochromic pattern from detrimental change by UV radiation.

The back 11 of the payment card 1 exhibits, in this instance, the same structure as the front 10, apart from one difference. The back 11 of the payment card 1 additionally comprises a nonthermochromic pattern 105. The term “nonthermochromic pattern” is understood to mean a pattern printed by means of a nonthermochromic ink.

In an alternative form, the back 11 of the payment card 1 may not contain any thermochromic or nonthermochromic printing, or only one of the two.

The nonthermochromic ink can be a water-based ink or an ink polymerizable under ultraviolet radiation.

The nonthermochromic pattern 105 is, in this instance, printed on the second support layer 100.

Before lamination, the adhesive layer 101, the tie layer 102 and the thermochromic pattern 103 of the nonlaminated card 1 each exhibit, for example, a thickness between 4 and 10 microns. In particular, the thermochromic pattern 103 exhibits a maximum thickness of 10 microns, preferably between 5 and 10 microns.

The thickness of the protective layer 104 can vary between 40 and 100 microns. The thickness of the support layer 100 can reach 350 microns.

After lamination, the payment card 1 loses in total approximately 5% of its thickness.

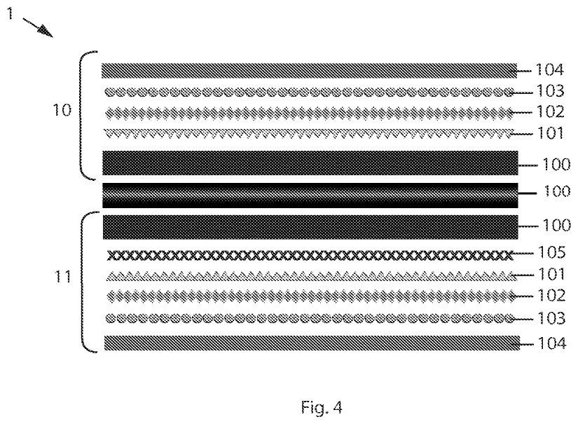

In another exemplary embodiment illustrated in FIG. 4, the smart card comprises three support layers 100. A third support layer 100, extending between the first support layer 100 and the second support layer 100, can comprise an RF antenna. This is the case in particular with a dual interface or contactless card, the RF antenna being, for example, connected to a chip module.

The process for the manufacture of the card, in this instance a payment card 1, is the following, applicable to one or both faces of the support. This process is targeted at manufacturing a card exhibiting a thermochromic pattern, the activation temperature of which is T1 and the deactivation temperature of which is T1′.

The assembling of the front 10 or of the back 11 of the payment card 1 is carried out in the following way.

A first stage of the process consists in providing one of the support layers 100.

The adhesive layer 101 is deposited on the support layer 100.

A first drying stage subsequently takes place, in which the adhesive layer 101 is dried.

The tie layer 102 is deposited on the dry adhesive layer 101.

A second drying stage subsequently takes place, in which the tie layer 102 is dried.

The thermochromic pattern 103 is subsequently printed on the dry tie layer 102.

The adhesive layer 101, the tie layer 102 and the thermochromic pattern 103 are, for example, deposited or printed by screen printing, by a coating machine, by flexography, by lithography, by rotogravure or by letterpress.

The thermochromic ink used in this instance exhibits an activation temperature T0=T1+δ and a deactivation temperature T0′=T1′+δ. δ is of between 2° C. and 5° C., typically 3° C.

A third drying stage takes place, in which the thermochromic pattern 103 is dried.

The protective plastic layer 104 is subsequently deposited on the thermochromic pattern 103.

The protective layer 104 also makes it possible to protect the thermochromic pattern 103 in order to prevent it from deteriorating during the frictional actions to which it may be subjected, for example in order to cause it to rise in temperature.

For the back 11 of the payment card 1, two intermediate stages take place after the stage of providing the second support layer 100. First of all, the nonthermochromic pattern 105 is printed on the second support layer 100. A stage of drying the nonthermochromic pattern 105 subsequently takes place.

The nonthermochromic pattern 105 printed at this point makes it possible to separate it from the thermochromic pattern 103 by two layers (the adhesive layer 101 and the tie layer 102). The two layers thus act as a barrier preventing the nonthermochromic pattern 105 from damaging the liquid crystals.

The drying stages each last at least 8 hours, preferably 24 hours.

The drying temperature is chosen according to the thermochromic ink. A minimum temperature is set to provide the drying function and a maximum temperature is set to avoid damaging the support layer. The drying stages are, for example, each carried out between 60° C. and 70° C., preferably at 65° C.

The assembly formed by these layers and patterns, and forming the front 10 or the back 11 of the payment card 1, is finally laminated.

The lamination is carried out under pressure, as hot lamination and then cold lamination.

The lamination parameters, in particular the temperature and the pressure, are chosen so as not to damage the liquid crystals.

The hot lamination is carried out at a pressure between 30 N/cm² and 200 N/cm², preferably of 120 N/cm².

The hot lamination is carried out at a temperature between 120° C. and 160° C., preferably at 125° C.

The cold lamination is carried out at a pressure between 50 N/cm² and 300 N/cm², preferably of 100 N/cm².

The cold lamination is carried out at a temperature between 10° C. and 20° C., preferably at 15° C.

The lamination is carried out over a total duration of between 15 and 40 minutes, for example 30 minutes.

The lamination stage causes the activation temperatures of the thermochromic ink to fall by δ degrees. Consequently, the thermochromic pattern obtained after lamination exhibits an activation temperature having a value substantially of T1 and a deactivation temperature having a value substantially of T1′.

The stages described above, with the exception of the lamination, are in this instance repeated twice in order to obtain the front and the back of the payment card 1.

When the payment card 1 comprises three support layers 100, the manufacturing process comprises a stage consisting in providing the third support layer 100. The third support layer 100 can, for example, be placed between the first support layer 100 and the second support layer 100 after stacking the layers of the front 10 and before stacking the layers of the back 11.

All the stages of printing, of assembling the layers and of lamination are, for example, carried out for large layers or sheets which are cut up after lamination into several cards with the desired format, in the case in point with the ID-1 type format. Several cards 1 are thus obtained.

When the card is a smart card, the manufacturing process comprises a final stage consisting in putting in the chip. The chip is put in individually for each card. A cavity is formed in the card, for example by means of a milling cutter. The cavity is formed over a few microns only. The cavity is formed until it reaches in particular the antenna of the third support layer 100. The chip is subsequently placed and adhesively bonded in the cavity. The contact of the chip with the antenna makes it possible to create the contact.

The sequence of the stages of manufacture of the payment card and the parameters at each of the stages have been chosen in order to obtain a card comprising at least one thermochromic pattern 103 and having satisfactory strength. By virtue of these choices, the liquid crystals are not damaged despite the various manufacturing constraints (use of various adhesives which might penetrate the microcapsules, lamination under pressure and at high temperature which might break the liquid crystals) and the payment card has the required strength properties.

The payment card 1 obtained can be used in the following way.

The thermochromic pattern 103 can be a security data inscription, for example a security element, such as a figure, a symbol, a sequence of characters or a cryptogram. The thermochromic pattern 103 is transparent and not visible when its temperature is outside the predefined range of temperatures. When the thermochromic pattern 103 is heated or cooled in order for its temperature to be in the predefined range of temperatures and in particular to reach the activation temperature, the thermochromic pattern 103 changes color and the security data become visible.

In this way, the security data, for example the cryptogram, are invisible to the naked eye when the temperature is outside the predefined temperature range. In particular, the security data are invisible to the naked eye when the temperature is lower than the activation temperature. An ill-intentioned person observing the payment card could not fraudulently acquire the security data since the activation temperature has not been reached.

If the security datum in the thermochromic pattern form constitutes a personal datum, also referred to as a variable datum because it is specific to each cardholder, such as a payment card verification cryptogram, when the user wishes to know the security data, they simply heat (for example by rubbing) the thermochromic pattern 103 in order to reach the activation temperature.

If the security datum in the thermochromic pattern 103 form is an invariable security element, the thermochromic pattern 103 can be revealed at a given temperature so as to verify the authenticity of the payment card 1. The process according to the invention is thus all the more applicable on a large scale, since it does not incorporate any individual personalization, the pattern being, for example, specific to the establishment and/or to the batch of cards, in particular by serial number ranges. Similarly, this embodiment finds an advantageous application in the field of identity cards by incorporating such a thermochromic security datum therein, for example in the form of a country-specific design. In this case, the activation temperature can be chosen in order to ensure the transparency of the thermochromic pattern 103 under normal conditions of use of the payment card 1. For example, the activation temperature is at least 40° C. The security data printed on the card thus become visible only after having exceeded this activation temperature.

In the various cases of use, the security of the payment card is improved in particular owing to the fact that the addition of such a thermochromic pattern considerably limits the slavish copying and/or that the security datum is not permanently visible.

Since the thermochromic ink is reversible, the process of appearance or of masking of the security data can be repeated indefinitely, throughout the entire lifetime of the payment card, according to the needs of the use thereof by its holder.

In another exemplary embodiment, the thermochromic pattern 103 can be used to mask security data, whether variable or not, while still making a large-scale application of the process according to the invention possible. Thus, for example, for the purpose of masking a security datum, such as a cryptogram, specific to the cardholder, this security datum being printed on the card by means of a nonthermochromic ink only during a personalization stage subsequent to the lamination stage, the thermochromic pattern 103 can constitute an area under the security data to be printed in personalization. The support and the security data are preferentially of the same color so that the security data are not visible outside the predefined temperature range of the thermochromic pattern 103. The choice of the color black makes it possible in particular to improve the contrast when the thermochromic ink is in the predefined temperature range. The security datum is then printed in superimposition on the thermochromic pattern 103 so as to render the security data invisible outside the predefined temperature range, which security data are then printed in the same color as the support, the inactive thermochromic pattern 103 being transparent, and so as to reveal the printed security data when the temperature renders the thermochromic pattern 103 active by making it change in color. The thermochromic pattern 103 is transparent when its temperature is outside the predefined range of temperatures and “undermasks” the security data. The thermochromic pattern 103 is colored and reveals the security data when its temperature is in the predefined range of temperatures. In order to render the thermochromic pattern transparent and to conceal the security data, the thermochromic pattern 103 is cooled in order for its temperature to be lower than the activation temperature or heated in order for its temperature to be greater than the deactivation temperature. Likewise, this embodiment finds in particular an advantageous application for identity cards.

In this case, the predefined temperature range can be chosen to correspond to a normal temperature range of use of the payment card by adjusting the properties of the thermochromic ink. Liquid crystals in the cholesteric phase have a helical structure. The transition temperature depends in particular on the pitch of the helix. Modification of the helical pitch of the liquid crystals thus makes it possible to modify the activation temperature of the thermochromic pattern 103.

The term “normal temperature range of use of the payment card” is understood to mean, for example, a temperature range of between 0° C. and 40° C., which corresponds to the possible range of ambient temperatures in which the payment card 1 is used. The security data printed on the card then become visible only outside this normal temperature range of use of the card.

The heating of the thermochromic pattern 103 can be carried out in various ways, for example by rubbing the thermochromic pattern 103 with a finger or by placing the payment card 1 or at least the area of the thermochromic pattern 103 in a hot environment. The cooling of the first pattern can be carried out by stopping the heating, for example by halting the rubbing with the finger. The cooling of the thermochromic pattern 103 can also be carried out by placing the payment card 1 in a cold environment.

The invention provides a card, the security of which is improved, while making easy and convenient use possible, in particular by virtue of the speed of activation of the thermochromic pattern. The smart card also exhibits the advantage of having good mechanical properties.

Other alternative forms, not illustrated, are mentioned below.

The smart card can be of a type other than a payment card, for example an identity card, a badge, or a ticket, and the like.

The support can comprise just one common support layer on the front and back of the card. In other words, a single substrate can be used without an additional support layer, said substrate then acting as support layer for the deposition and printing of other layers.

The smart card described comprises a thermochromic pattern on each of the front and the back. The card can comprise a different number of thermochromic patterns. For example, the card can comprise one or more thermochromic patterns solely on the front or the back.

The front and the back of the smart card can exhibit an identical structure of layers and of patterns.

The smart card can comprise other elements, in particular personalization elements, figures or items of information produced on the protective layer. These elements can be printed on the protective layer after lamination.

The smart card can additionally comprise an ultraviolet filter configured to protect the thermochromic pattern from ultraviolet radiation. The ultraviolet filter is, for example, incorporated in the protective layer. The protective layer can comprise, for example, an ultraviolet absorber. Alternatively, the ultraviolet filter can be a separate layer from the protective layer. The smart card can comprise an ultraviolet filter between the protective layer and the thermochromic pattern.

1. A laminated card comprising, in order:
a thermoplastic support layer;
an adhesive layer;
a tie layer;
a thermochromic pattern printed by way of a thermochromic ink; and
a protective plastic layer,
wherein the adhesive layer and the tie layer are both water-based or polymerizable under ultraviolet radiation, said thermochromic ink including a liquid crystal compound.

2. The laminated card as claimed in claim 1, wherein the liquid crystals are chiral nematic liquid crystals.

3. The laminated card as claimed in claim 2, wherein the liquid crystals are contained in microcapsules, said microcapsules having a diameter of less than 50 microns.

4. The laminated card as claimed in claim 1, wherein the tie layer and the thermochromic ink include an identical compound.

5. The laminated card as claimed in claim 4, wherein the liquid crystal compound constitutes between 10% and 30% by weight of the thermochromic ink.

6. The laminated card as claimed in claim 1, wherein the thermochromic ink and the tie layer have an acrylic matrix.

7. The laminated card as claimed in claim 1, wherein the card is a smart card.

8. A process for manufacture of a laminated card comprising:
providing a thermoplastic support layer;
depositing an adhesive layer on the support layer;
depositing a tie layer on the adhesive layer after dried,
the adhesive layer and the tie layer both being water-based and/or both being polymerizable under ultraviolet radiation;
printing a thermochromic pattern on the dried tie layer by way of a thermochromic ink, said thermochromic ink including a liquid crystal compound;
depositing a protective plastic layer on the dried thermochromic pattern; and
laminating an assembly.

9. The process as claimed in claim 8, wherein the laminating further comprises:
hot laminating at a temperature between 120° C. and 160° C., and a pressure between 30 N/cm² and 200 N/cm²; then
cold laminating at a temperature between 10° C. and 20° C., and a pressure between 50 N/cm² and 300 N/cm².

10. The process as claimed in claim 8 for manufacturing the laminated card, wherein the laminated card includes a thermochromic pattern of which exhibits an activation temperature T1, in which said thermochromic printing ink, before hot lamination, exhibits an activation temperature T0=T1+δ, where δ is of between 2° C. and 5° C.

11. The laminated card as claimed in claim 2, wherein the liquid crystals are contained in microcapsules, said microcapsules having a diameter of between 5 and 15 microns.

12. The laminated card as claimed in claim 2, wherein the tie layer and the thermochromic ink include an identical compound.

13. The laminated card as claimed in claim 3, wherein the tie layer and the thermochromic ink include an identical compound.

14. The laminated card as claimed in claim 4, wherein the liquid crystal compound constitutes between 10% and 20% by weight of the thermochromic ink.

15. The laminated card as claimed in claim 2, wherein the thermochromic ink and the tie layer have an acrylic matrix.

16. The laminated card as claimed in claim 2, wherein the card is a smart card.

17. The process as claimed in claim 8, wherein the laminating further comprises:
hot laminating at a temperature at 125° C., and a pressure of 120 N/cm²; then
cold laminating at a temperature at 15° C., and a pressure of 100 N/cm².

18. The process as claimed in claim 8, wherein the laminating further comprises:
hot laminating at a temperature at 125° C., and a pressure of 120 N/cm²; then
cold laminating at a temperature between 10° C. and 20° C., and a pressure between 50 N/cm² and 300 N/cm².

19. The process as claimed in claim 8, wherein the laminating further comprises:
hot laminating at a temperature between 120° C. and 160° C., and a pressure between 30 N/cm² and 200 N/cm²; then
cold laminating at a temperature at 15° C., and a pressure of 100 N/cm².
